(19) United States
(12) Patent Application Publication
(10) Pub. No.: US 2013/0027547 A1
(43) Pub. Date: Jan. 31, 2013

(54) APPARATUS AND METHOD FOR PROJECTING INFORMATION ONTO AN OBJECT IN THERMOGRAPHIC INVESTIGATIONS

(71) Applicants: Christian Homma, Vaterstetten (DE); Max Rothenfusser, Muenchen (DE)

(72) Inventors: Christian Homma, Vaterstetten (DE); Max Rothenfusser, Muenchen (DE)

(21) Appl. No.: 13/640,529

(22) PCT Filed: Mar. 8, 2011
(86) PCT No.: PCT/EP11/53424

§ 371 Date: Oct. 11, 2012

(30) Foreign Application Priority Data
Apr. 13, 2010 (DE) 102010014744.3

(51) Int. Cl. H04N 5/33

(52) U.S. Cl. 348/135; 348/E05.09

(57) ABSTRACT

An apparatus and a method for assessing an object to be tested by a thermography are provided with a more accurate and reliable thermography investigation. A thermography light image of the object is recorded by an infrared camera having a lens with a first lens axis. An item of information is projected onto the object by a projection unit having a lens with a second lens axis. A distributor unit positioned with respect to the lens axis of the infrared camera and of the projection unit is provided for reflecting the lens axis of the infrared camera or of the projection unit into the respective other lens axis in the direction of the object and transmitting or deflecting infrared light from the object to the infrared camera and deflecting or transmitting light from the projection unit to the object.

### CROSS REFERENCE TO RELATED APPLICATIONS

This application is the US National Stage of International Application No. PCT/EP2011/053424, filed Mar. 8, 2011 and claims the benefit thereof. The International Application claims the benefits of German application No. 10 2010 014 744.3 filed Apr. 13, 2010, both of the applications are incorporated by reference herein in their entirety.

### FIELD OF THE INVENTION

The present invention relates to an apparatus and a method for evaluating an object by means of thermography.

### BACKGROUND OF THE INVENTION

Active thermography is a modern, nondestructive testing method in which the heat generated in the test object as a result of excitation by external stimuli is recorded by means of a thermal imaging camera. By suitable choice of a type of excitation, for example by means of flash, hot air, ultrasound or induction, and evaluation methods it is possible to find defects, such as cracks or layer delaminations for example, that are contained in the part under test. At the same time such defects can equally be hidden, with the result that it is not possible to confirm their presence using many traditional methods, such as a penetration test for example, or visually. In investigations of said type two difficulties in particular emerge:

1. Often it is necessary to align the part under test exactly so that an excitation can be performed with precision. For example, it is necessary in the case of an acoustic thermography inspection to align an injection point for the ultrasound exactly. In an induction thermography inspection, precise alignment of a position of the part under test relative to the coil is required.

2. The test results are available in electronic form only as two-dimensional images, which means that interpreting the data is often beset with difficulties on account of the lack of a direct comparison with the part under test. This is the case in particular with spurious indicators which can be caused by contaminants or dirt. Hidden defects can only be localized indirectly because by their nature they are not visible at a surface.

Re 1.

Conventionally, suitable markers on the test object holder are used for exact positioning of a test object. However, such markers must be attached specifically for a particular test object. This is more or less time-consuming and complicated, depending on the number of variants of objects or parts that are to be tested. It must furthermore be ensured that the person carrying out the test also chooses the right type of marking.

Re 2.

In order to evaluate indicators it is necessary in most cases to compare a test image with the real part under test or test object. For that purpose the test object can be moved and rotated for example by hand in front of the monitor image. In most cases defects will be detected on the basis of conspicuous surface characteristics, such as, for example, ridges, layer delaminations, scratches, dents or the like. Localizing defects is made significantly more difficult in addition in the case of unstructured test objects.

### SUMMARY OF THE INVENTION

It is the object of the present invention to provide an apparatus and a method allowing a more accurate and more reliable thermographic examination of an object that is to be evaluated in comparison with the prior art. In particular, positioning the object and locating faults on the real object are to be carried out with improved accuracy.

The object is achieved by means of an apparatus according to the main claim and a method according to the coordinated claim.

According to a first aspect, an apparatus for evaluating an object by means of thermography is provided, comprising an infrared camera having a lens with a lens axis for recording at least one thermographic image of the object; a projection unit having a lens with a lens axis for projecting at least one item of information onto the object; a distributor device positioned on the lens axes of the infrared camera and the projection unit for reflecting the lens axis of the infrared camera or the projection unit into respective other lens axes in the direction of the object and for allowing through or deflecting infrared light from the object to the infrared camera and for deflecting or allowing through light from the projection unit to the object.

According to a second aspect, a method for evaluating an object by means of thermography is provided, comprising the following steps of: recording at least one thermographic image of the object by means of an infrared camera having a lens with a lens axis; projecting at least one item of information onto the object by means of a projection unit having a lens with a lens axis; reflecting the lens axis of the infrared camera or the projection unit into the respective other lens axis in the direction of the object and allowing through and deflecting infrared light from the object to the infrared camera and deflecting or allowing through light from the projection unit to the object by means of a distributor device positioned on the lens axes of the infrared camera and the projection unit.

A lens axis can be an optical axis of the lens. The optical axis can preferably be an axis of symmetry of the lens. Preferably a lens axis is an axis with respect to which the lens is rotationally symmetrical.

Reflecting a lens axis into another lens axis in the direction of an object means that a light beam is deflected along the lens axis to be reflected by means of a distributor device in such a way that after exiting the distributor device the light beam travels along the other lens axis in the direction of the object. The lens axis that is to be reflected is in this case reflected congruently or identically into the other lens axis by means of the distributor device. Conversely this means that after the distributor device at least a proportion of a light beam running from the object along a lens axis additionally travels along the other lens axis.

As a result of using a distributor device with the capability to separate visible light from infrared light it is possible, using a suitable projection unit, to project additional information onto the object that is to be tested.

The apparatus according to the invention enables identical angles of view of an infrared camera and a projection unit. Parallax errors caused by different angles of view onto three-dimensional objects are excluded in this way.

Further advantageous embodiments are claimed with the dependent claims.

According to an advantageous embodiment a device for comparing a position of the object registered by means of the recorded thermographic image with a reference position of the object is provided and the projection unit for projecting onto the object an item of information for the purpose of changing the position of the object in the direction of the reference position of the object. In order to achieve an exact positioning of the object to be tested, the position of the object can be recorded with the infrared camera and compared with an internal reference. The projection unit can then project at least one item of information onto the object in order to enable the object that is to be tested to be aligned accurately.

According to a further advantageous embodiment the information for changing the position of the object can be a color changing from red to yellow to green. In this case the color can particularly advantageously be the color of a thermographic image projected onto the object.

According to another advantageous embodiment the information for changing the position of the object can be a directional arrow projected onto the object.

According to a further advantageous embodiment at least one energy source can be provided for at least partially heating the object for the purpose of an active thermography examination.

According to another advantageous embodiment the projection unit can be provided for the purpose of projecting the thermographic image congruently with the object as information onto the object.

In order to evaluate defects, a result image of a thermographic survey can be projected onto the object. Since a beam path from infrared camera and projection unit is identical between the distributor device and the object, a congruent projection is possible. It is important that optical angles of view are the same and the infrared camera and the projection device are correctly aligned. In this way an evaluation is effectively simplified. According to this embodiment variant it is possible to project an infrared test image congruently onto an object that is to be tested. An effective improvement can be achieved in the interpretation of infrared images and defects can be located with greater accuracy. Detecting false indications, caused for example as a result of contaminants or dirt, is also made easier.

According to a further advantageous embodiment a rectifying device can be provided for equalizing imaging scales and distortions of optics of the infrared camera and the projection unit by means of calibration patterns and calibration algorithms. If a correction of a distortion of the two optics is to be carried out, this can be implemented by means of suitable calibration patterns and calibration algorithms. It may be that an apparatus according to the invention or a method according to the invention merely requires a rectification of a thermographic image, which can equally be referred to as a test image.

According to another advantageous embodiment the two lens axes can intersect at a 90° lens axis angle of intersection and an active layer of the distributor device can stand vertically on a plane spanned by the two lens axes and bisect the lens axis section.

According to a further advantageous embodiment the two lens axes can be arranged parallel to each other and an active layer and an additional active layer of the distributor device intersecting the lens axis to be reflected can stand parallel to each other and vertically on a plane spanned by the two lens axes and in each case intersect a lens axis at a 45° angle of intersection at a point of intersection, a straight line through said two points of intersection standing vertically on both lens axes. According to this embodiment variant an additional active layer can be positioned in the beam path of the lens axis to be reflected such that a light beam is additionally deflected through 90° and consequently the infrared camera and the projection unit can be arranged parallel to each other. In this way a compact overall design of an apparatus according to the invention can be provided.

According to another advantageous embodiment the active layer of the distributor device can be a semitransparent beam splitter or a tiltable optical mirror. A semitransparent beam splitter can in particular separate visible light from infrared light. A beam splitter of said type can for example allow infrared light to pass through and deflect visible light. A reverse case is equally possible in principle. Instead of a semitransparent beam splitter it is also possible to use a folding optical mirror which comes into service only during a back-projection. In this case there is no longer a requirement for an optical mirror of said type to be semitransparent.

According to a further advantageous embodiment the active layer of the distributor device can be a semitransparent beam splitter or a tiltable optical mirror and the additional active layer can be an optical mirror.

According to another advantageous embodiment at least one active layer can comprise glass, quartz glass, germanium, silicon, thallium bromioiodide, calcium fluoride, zinc selenide or other infrared-transparent materials.

According to a further advantageous embodiment at least one active layer can have a thickness of 0.1 to 0.5 mm.

### BRIEF DESCRIPTION OF THE DRAWINGS

The present invention is described in more detail with reference to two exemplary embodiments taken in conjunction with the figures, in which:

FIG. 1 shows a first exemplary embodiment of an apparatus according to the invention;

FIG. 2 shows a second exemplary embodiment of an apparatus according to the invention;

FIG. 3 shows a first exemplary embodiment of a method according to the invention.

### DETAILED DESCRIPTION OF THE INVENTION

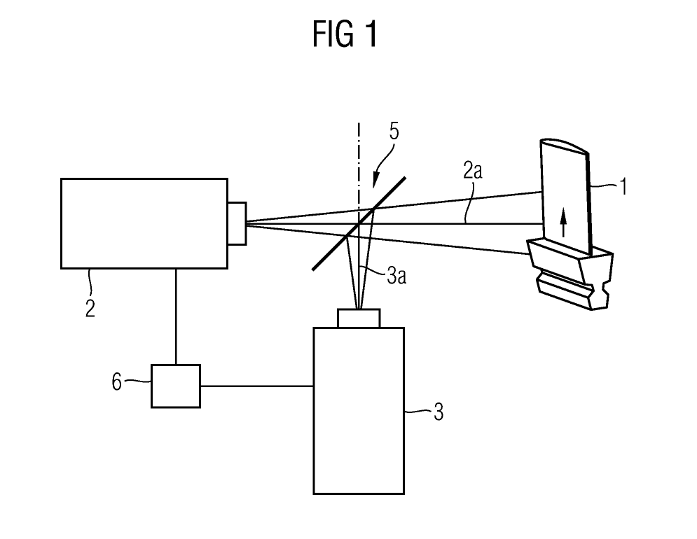

FIG. 1 shows a first exemplary embodiment of an apparatus according to the invention. According to this exemplary embodiment the apparatus has an infrared camera 2 having a lens with a lens axis 2a for recording at least one thermographic image 4 of an object 1 which is to be evaluated by means of thermography. In addition the apparatus has a projection unit 3 having a lens with a lens axis 3a for projecting at least one item of information onto the object 1. According to this exemplary embodiment an item of information of said type is information for changing the position of the object 1, and specifically a directional arrow projected onto the object 1. The apparatus additionally has a distributor device 5 which is arranged on the lens axes 2a and 3a of the infrared camera 2 and the projection unit 3. The distributor device 5 causes the lens axis 3a of the projection unit 3 to be reflected into the lens axis 2a of the infrared camera 2 in the direction of the object 1. The distributor device 5 deflects light from the projection unit 3 in the direction of the object 1. The distributor device 5 allows infrared light from the object 1 to pass through in the direction of the infrared camera 2. The distributor device 5 used has an effective surface. The effective surface, which can equally be referred to as an active layer, is a semitransparent beam splitter which allows infrared light to pass through and reflects visible light. The active layer can also be a tiltable optical minor. When a minor of said type is used an infrared image is recorded and the information is projected onto the object 1 sequentially in time. With the optical mirror in a swiveled-out position, the infrared camera 2 is able to record. With the optical minor in a swiveled-in position, the projection unit 3 can project the information, which in this case is a directional arrow, onto the object 1. A beam splitter can be a silicon wafer for example. Basically it is possible to interchange the position of the infrared camera 2 and the position of the projection unit 3. For that purpose a distributor device 5 allows visible light to pass through and reflects infrared light. The projection unit 3 can be a beamer for example. Additionally shown in FIG. 1 is a rectifying device 6 for equalizing imaging scales and distortions of optics of the infrared camera 2 and the projection unit 3 by means of calibration patterns and calibration algorithms.

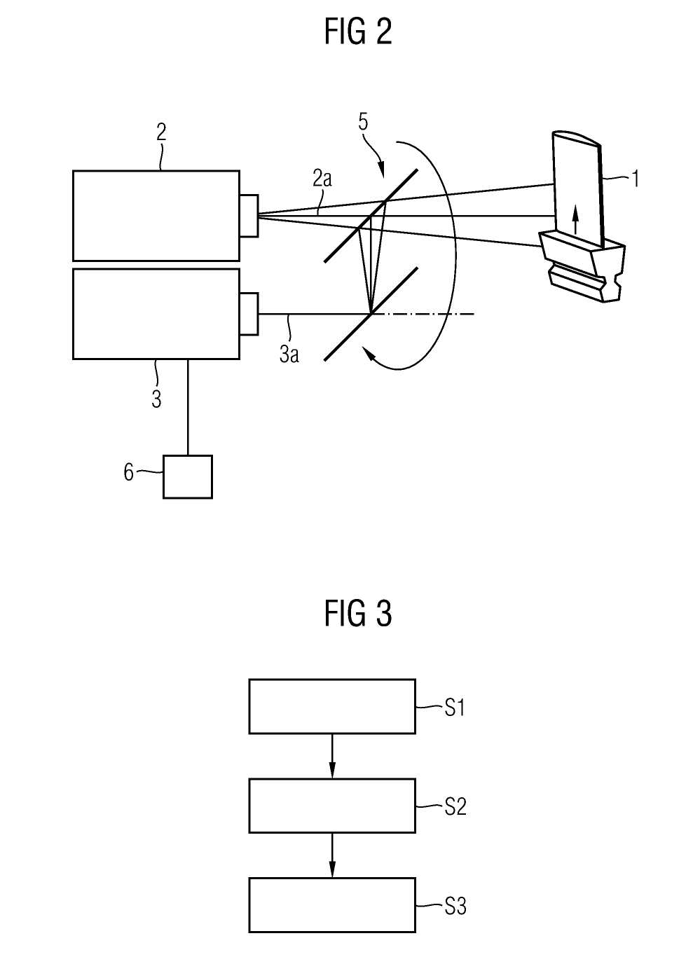

FIG. 2 shows a second exemplary embodiment of an apparatus according to the invention. In this case the apparatus according to FIG. 2 corresponds to the apparatus according to FIG. 1, with the following two differences:

Firstly, the two lens axes 2a and 3a are arranged parallel to each other.

Secondly, an additional active layer of the distributor device 5 is provided. An active layer according to FIG. 1 and the additional active layer of the distributor device 5 intersecting the lens axis 3a that is to be reflected are parallel to each other, stand vertically on a plane spanned by the two lens axes 2a and 3a and in each case intersect a lens axis 2a and 3a at a 45° angle of intersection at a respective point of intersection. A straight line through said two points of intersection stands vertically on both lens axes 2a and 3a. The active layer of the distributor device 5 can in this case be equally a semitransparent beam splitter or a tiltable optical mirror according to FIG. 1. The additional active layer is preferably an optical minor. According to the exemplary embodiment shown in FIG. 2, therefore, a minor is positioned in the beam path of the projection unit 3 such that, in contrast to FIG. 1, a light beam to the projection unit 3 is again deflected through 90° and consequently the infrared camera 2 and the projection unit 3 can be arranged parallel to each other. In this way a compact overall design of an apparatus according to the invention is provided.

A projection unit 3 according to FIG. 1 and FIG. 2 can be for example a beamer and in particular a miniaturized beamer. An item of information projected onto the object 1 by means of the projection unit 3 can be for example an image, color information, in the form of a colored circle for example, or the thermographic image 4 or thermography test image recorded by the infrared camera 2. The latter allows a direct comparison of test image or thermographic image 4 and object 1.

FIG. 3 shows an exemplary embodiment of the method according to the invention. A method of said type for evaluating an object by means of thermography, in particular active thermography, comprises at least the following three steps S1 to S3: At a first step S1, a distributor device is positioned on lens axes of an infrared camera and a projection unit. The lens axis of the projection unit is reflected into the lens axis of the infrared camera in the direction of the object by means of the distributor unit. In addition the distributor device allows infrared light to pass through from the object to the infrared camera and causes light to be deflected from the projection unit to the object. A second step S2 follows, wherein at least one thermographic image of the object is recorded by means of an infrared camera having a lens with the lens axis. At a further step S3, at least one item of information is projected onto the object by means of a projection unit having a lens with the lens axis. The lens axis of the infrared camera can be designated as the first lens axis. The lens axis of the projection unit can be designated as the second lens axis. A designation of this kind can essentially be applied throughout the entire patent application.

1-26. (canceled)

27. An apparatus for evaluating an object to be tested by a thermography, comprising:
an infrared camera having a lens with a first lens axis for recording a thermographic image of the object;
a projection unit having a lens with a second lens axis for projecting information onto the object; and
a distributor device positioned with respective to the first lens axis of the infrared camera and to the second lens axis of the projection unit for:
reflecting the first lens axis of the infrared camera or the second lens axis of the projection unit into respective other lens axis in a direction of the object;
transmitting or deflecting infrared light from the object to the infrared camera; and
deflecting or transmitting light from the projection unit to the object.

28. The apparatus as claimed in claim 27, further comprising a device for comparing a position of the object registered by the recorded thermographic image with a reference position of the object, and wherein the projection unit changes the position of the object in a direction of the reference position of the object.

29. The apparatus as claimed in claim 28, wherein information for changing the position of the object is a color of the thermographic image projected onto the object and the color changes from red to yellow to green, or wherein information for changing the position of the object is a directional arrow projected onto the object

30. The apparatus as claimed in claim 27, further comprising an energy source for at least partially heating the object for an active thermography.

31. The apparatus as claimed in claim 27, wherein the projection unit projects the thermographic image congruent with the object as the information onto the object.

32. The apparatus as claimed in claim 27, further comprising a rectifying device for equalizing imaging scales and distortions of optics of the infrared camera and the projection unit by calibration patterns and calibration algorithms.

33. The apparatus as claimed in claim 27, wherein the first and the second lens axes intersect at a 90° lens axis angle of intersection, and wherein an active layer of the distributor device stands vertically on a plane spanned by the first and the second lens axes and bisects the lens axis angle of intersection.

34. The apparatus as claimed in claim 33, wherein the active layer of the distributor device is a semitransparent beam splitter or a tiltable optical mirror, wherein the active layer of the distributor device comprises glass, quartz glass, germanium, silicon, thallium bromioiodide, calcium fluoride, zinc selenide or other infrared-transparent materials, and wherein the active layer of the distributor device has a thickness of 0.1 to 1.5 mm.

35. The apparatus as claimed in claim 27, wherein the first and the second lens axes are arranged parallel to each other, wherein an active layer and an additional active layer of the distributor device intersecting the first or the second lens axis to be reflected stand parallel to each other and vertically on a plane spanned by the first and the second lens axes, wherein the active layer and the additional active layer of the distributor device each intersects the first or the second lens axis at a 45° angle of intersection, and wherein a straight line through two intersection points stands vertically on both the first and the second lens axes.

36. The apparatus as claimed in claim 35, wherein the active layer of the distributor device is a semitransparent beam splitter or a tiltable optical mirror and the additional active layer is an optical mirror, wherein the active layer of the distributor device comprises glass, quartz glass, germanium, silicon, thallium bromioiodide, calcium fluoride, zinc selenide or other infrared-transparent materials, and wherein the active layer of the distributor device has a thickness of 0.1 to 1.5 mm.

37. A method for evaluating an object to be tested by a thermography, comprising:
recording a thermographic image of the object by an infrared camera having a lens with a first lens axis;
projecting information onto the object by a projection unit having a lens with a second lens axis;
positioning a distributor device on the first lens axis of the infrared camera and the second lens axis of the projection unit to reflect the lens axis of the infrared camera or the projection unit into respective other lens axis in a direction of the object;
transmitting or deflecting infrared light from the object to the infrared camera; and
deflecting or transmitting light from the projection unit to the object.

38. The method as claimed in claim 37, further comprising comparing a position of the object registered by the recorded thermographic image with a reference position of the object using a device, and wherein the projection unit changes the position of the object in a direction of the reference position of the object.

39. The method as claimed in claim 38, wherein information for changing the position of the object is a color of the thermographic image projected onto the object and the color changes from red to yellow to green, or wherein information for changing the position of the object is a directional arrow projected onto the object.

40. The method as claimed in claim 37, further comprising at least partially heating the object for an active thermography using an energy source.

41. The method as claimed in claim 37, wherein the projection unit projects the thermographic image congruent with the object as the information onto the object.

42. The method as claimed in claim 37, further comprising equalizing imaging scales and distortions of optics of the infrared camera and the projection unit by calibration patterns and calibration algorithms using a rectifying device.

43. The method as claimed in claim 37, wherein the first and the second lens axes intersect at a 90° lens axis angle of intersection, and wherein an active layer of the distributor device stands vertically on a plane spanned by the first and the second lens axes and bisects the lens axis angle of intersection.

44. The method as claimed in claim 43, wherein the active layer of the distributor device is a semitransparent beam splitter or a tiltable optical mirror, wherein the active layer of the distributor device comprises glass, quartz glass, germanium, silicon, thallium bromioiodide, calcium fluoride, zinc selenide or other infrared-transparent materials, and wherein the active layer of the distributor device has a thickness of 0.1 to 1.5 mm.

45. The method as claimed in claim 37, wherein the first and the second lens axes are arranged parallel to each other, wherein an active layer and an additional active layer of the distributor device intersecting the first or the second lens axis to be reflected stand parallel to each other and vertically on a plane spanned by the first and the second lens axes, wherein the active layer and the additional active layer of the distributor device each intersects the first or the second lens axis at a 45° angle of intersection, and wherein a straight line through two intersection points stands vertically on both the first and the second lens axes.

46. The method as claimed in claim 45, wherein the active layer of the distributor device is a semitransparent beam splitter or a tiltable optical mirror and the additional active layer is an optical mirror, wherein the active layer of the distributor device comprises glass, quartz glass, germanium, silicon, thallium bromioiodide, calcium fluoride, zinc selenide or other infrared-transparent materials, and wherein the active layer of the distributor device has a thickness of 0.1 to 1.5 mm.
